(19) United States
(12) Patent Application Publication
(10) Pub. No.: US 2007/0077485 A1
(43) Pub. Date: Apr. 5, 2007

(54) Thin film for package of alkaline battery and thin air battery using the same

(76) Inventors: Koshi Takamura, Osaka (JP); Harunari Shimamura, Osaka (JP); Nobuharu Koshiba, Nara (JP)

Correspondence Address: MCDERMOTT WILL & EMERY LLP, 600 13TH STREET, NW, WASHINGTON, DC, 20005-3096, US

(21) Appl. No.: 10/581,113

(22) PCT Filed: Apr. 19, 2005
(86) PCT No.: PCT/JP05/07463

§ 371 Date: May 31, 2006

(30) Foreign Application Priority Data
Jun. 1, 2004 (JP) 2004-163175

(51) Int. Cl. H01M 2/12; H01M 12/06

(52) U.S. Cl. 429/82; 429/27

(57) ABSTRACT

There is provided a thin air battery comprising a power-generating element including air diffusion paper and a water repellent film, the power-generating element sealed in a package composed of first and third sheet layers that cover the air electrode side and negative electrode side of the power-generating element, and a second sheet layer disposed in the peripheral portion between the two sheet layers and joined to the two sheet layers. The sheet layers are each composed of a thin film formed by stacking an alkali resistant polymer film having hydrogen gas permeability and a polymer film having gas barrier properties, and in each of the first and third sheet layers, the polymer film having hydrogen gas permeability is disposed on the internal surface side. According to the present invention, a thin air battery that has high energy density and has excellent long-term reliability is provided.

### TECHNICAL FIELD

The present invention relates to thin air batteries that have very high energy density and have excellent long-term reliability. The present invention also relates to a thin film for a package used in an alkaline battery, such as an air battery.

### BACKGROUND ART

Since an zinc air battery used an air electrode using oxygen in the air as a positive electrode active material, it has been applied to various devices for aids to navigation, various communications, and telephones, as an economical power source that can be used for a long period without maintenance. Among these, since a button-shaped zinc air battery has features such as high energy density, lightweight and economical, compared with other batteries having similar shapes, the range of application thereof have been expanding, and the present major application thereof is a power source for hearing aids.

However, since the button-shaped air battery has a disadvantage that current able to be outputted is small, it is difficult to use as the main power source for portable electronic devices or small audio systems. As means for increasing current that can be outputted, a method for enlarging the battery size can be considered. However, there is a problem wherein if the battery size is simply enlarged, the battery cannot be accommodated in the volume allotted to the battery in a small electronic device.

For such a problem, two countermeasures can be considered. One is a method to improve current collecting efficiency so as to increase current that can be outputted (for example, Patent Document 1). The other is a method to effectively use the volume allotted to the battery in a small electronic device, and to increase current that can be outputted by substituting the button-shaped battery with a sheet-shaped battery (for example, Patent Documents 1 to 3).

[Patent Document 1]: Japanese Laid-Open Patent Publication No. 63-96873

[Patent Document 2]: Japanese Laid-Open Patent Publication No. 63-138668

[Patent Document 3]: Japanese Laid-Open Patent Publication No. 63-131474

### DISCLOSURE OF INVENTION

### PROBLEMS TO BE SOLVED BY THE INVENTION

In a button-shaped air battery of a conventional example, a zinc alloy and a gelled electrolyte are housed in a negative electrode case made of a metal; air diffusion paper, a water repellent film, an air electrode, and a separator are disposed in a positive electrode case made of a metal having an air hole; and these negative electrode case and positive electrode case are caulked and sealed with a gasket therebetween. In this button-shaped air battery, since the bondage of the negative electrode and the positive electrode is sufficiently maintained, stable discharging characteristics can be obtained even after storage.

However, since the above-described Patent Documents 1 to 3 are of configurations using thin films for outside casings, the following problems arise during the storage period.

Hydrogen gas is generated from the negative electrode caused by impurities mixed in the negative electrode and a gap is produced in the vicinity of the surface of the negative electrode to reduce the reaction area, resulting in the lowering of discharge capacity. Since the internal resistance increases with the reduction of the reaction area, the IR drop during discharge becomes excessive, and the average discharge voltage is lowered. Therefore, the energy density of the battery is markedly lowered. To solve this problem, a method to release hydrogen gas generated in the battery to the outside, or to suppress the generation of hydrogen gas is required.

Furthermore, in the above-described Patent Document 1, since a negative electrode active material is applied onto a current collector, the chance of mixing a foreign metal having a low hydrogen overvoltage, such as iron, from a kneader or a coating machine in the step for kneading the active material with a binder, or in the step for coating the current collector with the kneaded active material is high, and the generation of hydrogen gas becomes more significant. In the above-described Patent Document 2, since a metal having a low hydrogen overvoltage, such as nickel foil and stainless-steel foil, is used as the negative electrode current collector, the generation of hydrogen gas from the negative electrode becomes significant. In the above-described Patent Document 3, since a negative electrode current collector and the aluminum foil of a package are integrated to be used, if the current collector is damaged during the manufacturing step for coating the current collector with the negative electrode active material, the electrolyte penetrates to the aluminum foil during the storage period of the battery, the aluminum foil is corroded by the electrolyte to generate gas and to expand the battery, and finally, rupture or the leakage of the electrolyte may occur.

It is an object of the present invention to solve the above problems, and to provide a thin air battery having a very high energy density and excelling in long-term reliability.

### MEANS TO SOLVE THE PROBLEM

The thin air battery of the present invention comprises:

a power-generating element composed of a laminate in which air diffusing paper, a water repellent film, an air electrode, a separator, and a negative electrode are stacked in this order, and an electrolyte is contained in the air electrode, separator, and negative electrode;

a package composed of a first sheet layer having air inlet holes and covering the air electrode side of the power-generating element, a third sheet layer covering the negative electrode side of the power-generating element, and a second sheet layer located in the peripheral portion between the first sheet layer and the third sheet layer and joined to the two sheet layers; and

a lead of the air electrode and a lead of the negative electrode drawn out of the package from between the second sheet layer and the first sheet layer or third sheet layer.

The first sheet layer, second sheet layer, and third sheet layer each comprise a thin film formed by stacking at least an alkali-resistant polymer film having hydrogen gas permeability and a polymer film having gas barrier properties; and in each of the first sheet layer and the third sheet layer, the polymer film having hydrogen gas permeability is disposed on the internal surface side.

The present invention also provides a thin film for a package of an alkaline battery formed by stacking at least an alkali-resistant polymer film having hydrogen gas permeability and a polymer film having gas barrier properties.

According to the configuration of the present invention, in a sheet-like package, a polymer film having hydrogen gas permeability is disposed on the internal surface side of the battery. Therefore, even if hydrogen gas is generated from the negative electrode, the hydrogen gas is discharged out of the battery along the polymer film having hydrogen gas permeability, and the expansion of the battery during the storage period can be prevented. The polymer film having gas barrier properties prevents the invasion of water vapor from the outside to the inside of the battery, and the evaporation of the aqueous electrolyte in the battery to the outside during the storage period of the battery. In addition, the polymer film having gas barrier properties prevents the invasion of carbon dioxide into the battery, and the reaction wherein the alkaline electrolyte is neutralized.

The mechanism of discharging hydrogen gas out of the battery in the air battery of the present invention will be described in further detail. Although hydrogen gas generated from the negative electrode can easily penetrate into the layer of a polymer film having hydrogen gas permeability, the penetration rate for the layer of a polymer film having gas barrier properties is extremely low, and penetration in the thickness direction of the sheet-like package becomes difficult. The hydrogen gas is discharged mainly out of the battery after penetrating through surfaces wherein the sheet-like package is joined, specifically, the joint surface between the first sheet layer and the second sheet layer, and the joint surface between the third sheet layer and the second sheet layer. More strictly, the two routes of the penetration of the hydrogen gas are the layer in the horizontal direction to the battery thickness direction of hydrogen gas permeating material positioned on each joint surface, and the joint boundary, and the rate of the penetration of the hydrogen gas in these routes are different. Since the hydrogen gas permeating material in the joint boundary has been heat-cured due to heat welding, the penetration rate of the hydrogen gas tends to retard. Therefore, it is preferable to increase the thickness of the layer of the hydrogen gas permeating material to some extent to secure the route for permeating the hydrogen gas.

Next, the effect of the polymer film having gas barrier properties will be described in further detail. The polymer film having gas barrier properties has functions to retard the permeation of all or any of water vapor, carbon dioxide, and oxygen, compared with a polymer film having hydrogen gas permeability. By the function to retard the permeation of water vapor, the invasion of water vapor from the outside to the inside of the battery, and the evaporation and decrease of the aqueous electrolyte in the battery to the outside of the battery can be prevented. By the function to retard the permeation of carbon dioxide, the invasion of carbon dioxide into the battery to neutralize the alkaline electrolyte can be prevented. Furthermore, by the function to retard the permeation of oxygen, the discharge reaction of the negative electrode active material due to the reaction of oxygen with the negative electrode active material can be prevented. By these functions, in comparison with the case wherein a polymer film having gas permeability is used alone for the package sheet, the storage characteristics of the battery are improved, and a battery having high long-term reliability can be obtained.

Since the degradation of the alkaline electrolyte can be suppressed and rise in the internal resistance of the battery during storage can be suppressed by the above-described functions, the discharge characteristics are not lowered even after storage for a long period of time. In addition, the self-discharge reaction of the negative electrode active material can be suppressed, and the acceleration of hydrogen gas generation can be prevented.

The polymer film having hydrogen gas permeability is preferably composed of one or two or more polymer materials selected from the group consisting of polyethylene, polypropylene, and polysulfone. Since the film composed of these materials has relatively high hydrogen gas permeation rate, it can easily release hydrogen gas generated in the battery to the outside, and the expansion of the battery can be suppressed to a minimum. The film composed of these materials also has excellent heat welding properties, and can prevent the creep and leakage of the electrolyte from the joint to the outside.

The polymer film having hydrogen gas barrier properties is preferably composed of one or two or more polymer materials selected from the group consisting of polyethylene naphthalate, polyethylene terephthalate, polyphenylene sulfide, polyamide, polyvinyl chloride, ethylene-vinyl alcohol copolymers, ethylene-vinyl acetate copolymers, and ionomer resins. Even if the polymer film having hydrogen gas permeability is damaged in the step for assembling the battery, and the alkaline electrolyte contacts the polymer film having gas barrier properties, since the film composed of these materials is not corroded by the electrolyte, no gas generation is caused, and the leakage of the electrolyte to the outside can be prevented.

Other materials preferable as the polymer film having gas barrier properties consist of fluorine-containing polymer materials. The effect to suppress the permeation of water vapor is much higher than the above-described polymer film having gas barrier properties, and the invasion of water vapor from the outside of the battery into the battery, and the evaporation of the aqueous solution of the electrolyte in the battery to the outside of the battery can be almost completely prevented.

It is preferable that at least one of the first sheet layer, the second sheet layer, and the third sheet layer contains a metal sheet layer not corroded by the aqueous alkaline solution. Since the metal sheet layer almost completely prevents the permeation of gas, the invasion of water vapor, carbon dioxide, and oxygen into the battery can be almost completely prevented. Even if the polymer film having hydrogen gas permeability or the polymer film having gas barrier properties is damaged in the battery assembling step or during storage, the metal sheet layer not corroded by the alkaline electrolyte prevents the leakage of the alkaline electrolyte to the outside.

The thin film for the package of an alkaline battery formed by stacking at least a polymer film having alkali resistance and hydrogen gas permeability and a polymer film having gas barrier properties enables to make a battery thin not only an air battery but also a battery system, as long as the battery system uses an alkaline electrolyte. For example, such batteries include primary batteries, such as an alkaline manganese battery, mercury battery, silver oxide battery, nickel-zinc battery, and nickel-manganese battery. The examples of secondary batteries include a nickel-cadmium battery and nickel-metal hydride battery.

### ADVANTAGES OF THE INVENTION

According to the present invention, hydrogen gas generated from the negative electrode during storage due to impurities or the like can be discharged to the outside of the battery, and the expansion of the battery can be suppressed. In addition, the permeation of water vapor into and out of the battery, and the invasion of carbon dioxide can be suppressed, and the degradation of the electrolyte can be prevented. Furthermore, the invasion of oxygen into the battery can be prevented, and the self-discharge of the negative electrode active material can be prevented. Therefore, the elevation of internal resistance during the storage period can be suppressed, and a thin air battery having high long-term reliability can be provided.

### BRIEF DESCRIPTION OF DRAWINGS

FIG. 1 is a vertical sectional view of a thin air battery according to an example of the present invention; and

FIG. 2 is a perspective view of the battery viewed from the positive electrode side.

### BEST MODE FOR CARRYING OUT THE INVENTION

The embodiments of the present invention will be described below referring to the drawings.

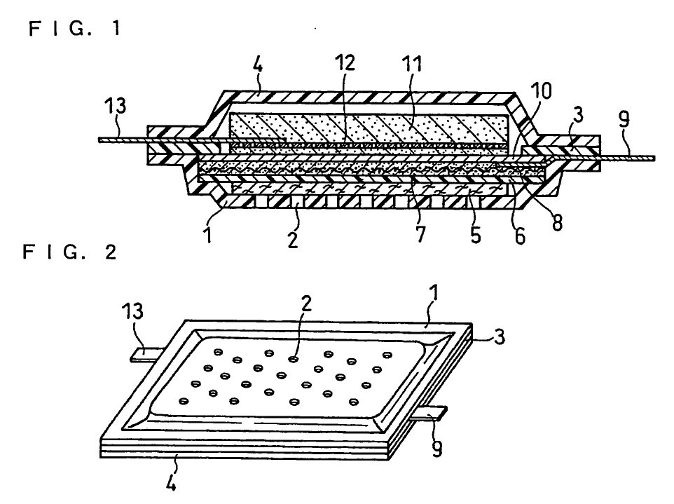

FIG. 1 is a sectional view of a thin air battery according to an embodiment of the present invention; and FIG. 2 is a perspective view wherein the positive electrode side is up. A package is composed of a first sheet layer 1, a second sheet layer 3, and a third sheet layer 4. The first sheet layer 1 has an air inlet hole 2. In the package, a laminate of air diffusion paper 5, a water repellent film 6, an air electrode 7, a separator 10, and a negative electrode 11 is housed. In the laminate, although an alkaline electrolyte is initially present in the vicinity of the surface of the negative electrode 11, the electrolyte gradually penetrates into the separator, and further into a part of the air electrode. The package is composed by joining the first sheet layer 1 to the third sheet layer 4 through the second sheet layer 3 at peripheral portions. A lead 9 of the air electrode 7 and a lead 13 of the negative electrode 11 are led to the outside from between the second sheet layer and the first or third sheet layer.

Each of the first to third sheet layers 1, 3, and 4 constituting the package is composed of at least a polymer film having hydrogen gas permeability and a polymer film having gas barrier properties. These layers can be of a laminate structure wherein two or more layers are stacked. The method for fabricating these layers can be any of a method for adhering sheets to each other using an adhesive called an anchor coating agent, a method for coating a sheet to be a base material with a material in a molten state, or a method for bonding sheets to each other by thermal welding. Although examples of anchor coating agents include isocyanate-based compounds, polyethylene imine, modified polybutadiene, and organic titanate-based compounds, those having alkali resistance are preferable.

The hydrogen gas permeating material is preferably selected from the group consisting of polyethylene (PE), polypropylene (PP), and polysulfone (PSF). Although other polymer materials having hydrogen gas permeability can be used, a material that can be easily welded is preferable. These materials can be oxidation-modified and polarized to improve adhesion of sheets to each other.

The gas barrier material is selected from the group consisting of polyethylene naphthalate (PEN), polyethylene terephthalate (PET), polyphenylene sulfide (PPS), polyamide (PA), polyvinyl chloride (PVC), ethylene-vinyl alcohol copolymers (EVOH), ethylene-vinyl acetate copolymers (EVA), and ionomer resins (IONO), and the combination of two or more of them can also be used. Since these polymer materials have alkali resistance, in case that a flaw or pinhole is produced in the hydrogen gas permeating material, and contact with the alkaline electrolyte occurs, the leakage of the electrolyte is prevented because corrosion reaction is not caused. By combining two or more, the effect of preventing the leakage of the electrolyte is enhanced.

Any fluorine-containing polymer materials can be used as preferable gas barrier materials as long as they have water repellency, and examples include polytetrafluoroethylene (PTFE), polyvinylidene fluoride (PVDF), tetrafluoroethylene-perfluoroalkylvinylether copolymer (PFA), tetrafluoroethylene-hexafluoropropylene copolymer (FEP), and the like.

There are two methods for composing a package sheet using a fluorine-containing polymer material. One is a method wherein a fluorine-containing polymer material is used as the base material, and a hydrogen gas permeating material is adhered to this. In this case, since the fluorine-containing polymer material is non-adhesive, and is difficult to adhere to the hydrogen gas permeating material, it is preferable to previously modify the adhering surface of the fluorine-containing polymer material. Two major methods for surface modification are surface roughing by blasting process using alumina powder; and a method to introduce a hydrophilic functional group, such as a hydroxyl group, onto the surface of a fluorine-containing polymer material by corona discharge or oxygen plasma. However, surface modifying methods are not limited thereto as long as a method improves the adhesion of the fluorine-containing polymer material. The method for adhering a hydrogen gas permeating material to a sheet consisting of a fluorine-containing polymer material can be any of a method for adhering sheet layers to each other using an adhesive called an anchor coating agent, a method for coating a base material sheet made of a fluorine-containing polymer material with a hydrogen gas-permeable material in a molten state, or a method for bonding sheets to each other by thermal welding. Although examples of anchor coating agents include isocyanate-based compounds, polyethyleneimine, modified polybutadiene, and organic titanate-based compounds, those having alkali resistance are preferable.

The second method for composing a package sheet using a fluorine-containing polymer material is a method for coating a surface-modified sheet of a hydrogen gas permeating material with a fluorine-containing polymer material. Although the surface modification of the sheet of a hydrogen gas permeating material is generally performed by roughening the surface by blast processing using the above-described alumina powder, any method can be used as long as it can improve the adhesion to the fluorine-containing polymer material. Although methods for the coating with a fluorine-containing polymer material include spray coating, dip coating, roll coating and the like, the methods are not limited thereto. After coating with the fluorine-containing polymer material, the sheet can be baked at a temperature of the melting point of the fluorine-containing polymer material or below to improve the adhesion to the base material. When baking is performed, polysulfone having a melting point of 200° C. or above is preferably used as the hydrogen gas permeating material.

A metal sheet layer not corroded by an alkaline aqueous solution used as at least one of the first to third sheet layers can be any metal not corroded by alkali, and gold, platinum, nickel, copper, tin, titanium, silicon or the like can be used. However, if the hydrogen gas permeating material sheet or the gas barrier sheet is damaged and the metal sheet layer contacts the alkaline electrolyte, hydrogen gas is generated from the surface of the metal sheet layer, and the battery may be expanded. In order to suppress the generation of hydrogen gas, the use of copper or tin, which has high hydrogen overvoltage, is preferable. The stacking order is preferably either hydrogen gas permeating material sheet/gas barrier sheet/metal sheet, or hydrogen gas permeating material sheet/metal sheet/gas barrier material sheet. There are two methods for composing a package sheet using a metal sheet. One is a method to form the metal sheet layer by vapor-depositing a metal on a hydrogen gas permeating material sheet or a gas barrier sheet. The other is a method to adhere a metal foil and a hydrogen gas permeating material or a gas barrier sheet to each other using an adhesive called an anchor coating agent. Although anchor coating agents include isocyanate-based compounds, polyethyleneimine, modified polybutadiene, organic titanate-based compounds and the like, any anchor coating agent can be used as long as it is alkali resistant.

The air diffusion paper 5 is a layer to evenly diffuse the air taken in from the air inlet hole, and is composed of a material such as vinylon and mercerized pulp. The water repellent film 6 is composed of polytetrafluoroethylene, and used for supplying oxygen to the air electrode 7 and preventing the leakage of the electrolyte in the battery to the outside. The air electrode 7 has a sheet structure wherein manganese oxide, activated carbon, and a conductive material are mixed together with a fluorine-based binder and pressure-packed in a net-shaped current collector 8, and a polytetrafluoroethylene film is pressure-bonded to the side facing the water repellent film 6. The net-shaped current collector is selected from stainless steel, titanium, or nickel-plated stainless steel.

The separator 10 is composed of one selected from a polyethylene microporous film, polypropylene microporous film, cellophane, non-woven vinylon fabric, and the like; or two of these that have been stacked or integrated. The air electrode 7 and the separator 10 can be integrated with a binder, and an example of the binder is polyvinyl alcohol.

In the negative electrode 11, a typical negative electrode active material is a zinc alloy. The zinc alloy is formed from zinc and a metal species having high hydrogen overvoltage in order to suppress the generation of hydrogen gas, and the metal species having high hydrogen overvoltage is selected from the group consisting of aluminum, calcium, bismuth, tin, lead, and indium. Two or more of these can be contained. The shape of the negative electrode 11 can be plate-like or sheet-like formed by bonding the particulated material to the current collector 12. The shape of the current collector can be any of foil and net, and in order to suppress the generation of hydrogen gas from the negative electrode, the use of copper or tin which is metal species having high hydrogen overvoltage is preferable. The methods for bonding the active material to the current collector in the negative electrode include a method to knead the active material with a binder and adhere to the current collector, or a method to deposit the active material on the current collector by electroplating. In the case of a particulate active material, the powder of a gelling agent to be contained in the electrolyte can be mixed. Negative electrode active materials other than the zinc alloy include metals, such as aluminum and magnesium, which can be used as an equivalent electrode component.

As the negative electrode 11, a gel formed by mixing a gelling agent with the particulate active material, and further mixing an alkaline electrolyte can also be used as it is. By gelling, electronic contact between particulates of the active material, and the current collecting properties of the particulate active material can be maintained. The shape of the current collector can be any of a rod, foil, and net, and as the material for forming the surface of the current collector, the use of metal species having high hydrogen overvoltage, such as copper, tin, brass, and indium is preferable. These metal species can also be formed on the surface of the current collector by electrolytic plating or electroless plating.

As the alkaline electrolyte, an aqueous solution of potassium hydroxide within a concentration range of 28 to 45% by weight is used. In the electrolyte, zinc oxide (ZnO) can be dissolved to suppress the self-discharge of zinc. The concentration of ZnO to be dissolved includes the range until it is saturated in the aqueous solution of KOH. Furthermore, an organic anticorrosive for suppressing the generation of hydrogen gas, such as fluoroalkyl polyoxyethylene, can be dispersed. The electrolyte can be gelled. The examples of gelling agents include carboxymethyl cellulose, polyvinyl alcohol, polyethylene oxide, polyacrylic acid, sodium polyacrylate, potassium polyacrylate, chitosan gel, and the like; and the degree of polymerization, degree of crosslinking, and molecular weight of each gelling agent can be varied, and two or more of these can be mixed.

In the first layer 1 of the package, the air diffusion paper 5 is disposed so as to envelope the air inlet hole 2; the water repellent film 6, the air electrode 7, and the separator 10 having substantially the same area are sequentially disposed thereon; and the second sheet layer 3 previously formed so as to cover only the peripheral portions of the separator 10 is joined using heat welding or adhesive to obtain a positive electrode side component. To simplify the process, a joining method using heat welding is preferable. To provide the first layer 1 with a space for housing the air diffusion paper, the repellent film, the air electrode, and the separator, a depression can be previously produced by heat pressing. The lead 9 of the air electrode 7 is previously joined to the current collector 8 by resistance welding. The lead 9 is selected from stainless steel, nickel, and titanium.

The third sheet layer 4.of the package houses the negative electrode 11 containing an electrolyte to obtain a negative electrode side component. The positive electrode side component and the negative electrode side component are faced to each other, and joined using heat welding or adhesive. To simplify the process, a joining method using heat welding is preferable. At this time, joining can be performed under a reduced pressure in the state wherein the air hole of the positive electrode side component is sealed. To provide the third sheet layer 4 with a space for housing the negative electrode, a depression can be previously produced by heat pressing. The lead 12 of the negative electrode is previously joined to the negative electrode 11 by resistance welding or ultrasonic welding. The lead 12 is selected from a metal having high hydrogen overvoltage in order to suppress the generation of hydrogen gas. The preferable materials include copper, tin and the like.

### EXAMPLES

The examples of the present invention will be described below for a thin air battery fabricated to have a length of 34 mm, a width of 50 mm, and a thickness of 2.0 mm or less, referring to the drawings.

### Example 1

For sheet layers 1, 3 and 4 of a package, an acid-modified polypropylene (PPa) having a thickness of 0.02 mm was used as a hydrogen gas permeating material, PEN having a thickness of 0.035 mm was used as a gas barrier material, and a sheet constituted to be a three-layer structure of a total thickness of 0.075 mm wherein the both surfaces of the PEN was coated with PPa was used (tab-film (PPa—N), manufactured by Dai Nippon Printing Co. Ltd.).

The first sheet layer 1 was drawn using a hot press to have a depth of 0.6 mm. In the depression, vinylon fiber paper (thickness: 0.1 mm) as air diffusion paper 5 was placed so as to cover over an air inlet hole 2, and spot bonded with pitch to fix. On the vinylon fiber paper, a fine porous film of polytetrafluoroethylene (PTFE) (thickness: 0.1 mm) as a water repellent film 6, an air electrode 7 (thickness: 0.3 mm), and a fine porous film of polypropylene (PP) (thickness: 0.05 mm) as a separator 10 were sequentially stacked. Over the portion from the peripheral to 2.0 mm therefrom of the surface contacting the separator, of the air electrode 7, pitch was applied as a sealant. The second sheet layer 3 was made to have a donut shape by cutting off the center portion, bonded to the separator by heat welding so as to overlap only the portion from the peripheral to 2.0 mm therefrom of the second sheet layer 3, and thereafter, bonded to the first sheet layer 1 by heat welding to obtain a positive electrode side component.

As an air electrode 7, what was fabricated in a sheet structure in the following procedures was used.

First, manganese oxide, activated carbon, ketjen black, and PTFE powder was well mixed in a weight ratio of 40:30:20:10, pressure packed in a nickel plated 30-mesh net-like stainless steel current collector, and a PTFE fine porous film was pressure bonded to the surface facing the water repellent film 6. Thereafter, the structure was cut into a predetermined size, and a part of the current collector was exposed to connect a lead 9 by resistance welding. Nickel was used as the lead 9.

As an active material of the negative electrode 11, particulate zinc alloy containing Al, Bi, and In within a range between 50 and 1000 ppm was used. Specifically, after pulverizing a zinc alloy containing 30 ppm of Al, 150 ppm of Bi, and 400 ppm of In by an atomizing method, the powder was screened so that the particle diameter of the whole powder was 500 μm or less, and 30% by weight of particles of 250 to 500 μm were contained. As the current collector, a copper foil having a thickness of 20 μm was processed to have numerous through-holes and irregularities. A negative electrode was formed by mixing 1% by weight of carboxymethyl cellulose powder to the zinc alloy, and hot-pressed to the current collector at 200° C. A lead 13 was formed using copper, and joined to the current collector by ultrasonic welding.

An electrolyte was prepared by dissolving 5% by weight of ZnO in a 40% by weight aqueous solution of potassium hydroxide.

The third sheet layer 4 was drawn using a hot press so as to have a depth of 1.0 mm. After placing a negative electrode in the depression, an electrolyte having a mass ratio of the electrolyte and the negative electrode active material became 0.5:1 was injected to obtain a negative electrode side component.

Finally, the positive electrode side component was joined to the negative electrode side component by thermal welding to fabricate a thin air battery. The packing quantity of zinc was designed so that the theoretical discharge capacity of the air battery became 2500 mAh.

### Examples 2 to 14

Hydrogen gas permeating materials, gas barrier materials, and metal materials, the thicknesses thereof, and the compositions and thicknesses of packages composed of these materials are shown in Table 1. The hydrogen gas permeating materials and the gas barrier materials were adhered together by evenly roll-coating modified polybutadiene as an anchor coating agent with a substantially negligible thickness on the surface of the gas barrier material sheets, and bonding the hydrogen gas permeating material sheets thereto. Except using these, thin air batteries were fabricated in the same configurations as in Example 1.

TABLE 1

| | Hydrogen gas permeating | Gas barrier material | Metal material | Composition and |
|---|---|---|---|---|
| | material and thickness | and thickness | and thickness | thickness of |
| | thereof (mm) | thereof (mm) | thereof (mm) | package (mm) |
| Example 1 | PPa 0.02 | PEN 0.035 | — | PPa/PEN/PPa 0.075 |
| Example 2 | PPa 0.02 | PET 0.035 | — | PPa/PET/PPa 0.075 |
| Example 3 | PPa 0.02 | PPS 0.035 | — | PPa/PPS/PPa 0.075 |
| Example 4 | PE 0.02 | PEN 0.035 | — | PE/PEN/PE 0.075 |
| Example 5 | PE 0.02 | PET 0.035 | — | PE/PET/PE 0.075 |
| Example 6 | PE 0.02 | PPS 0.035 | — | PE/PPS/PE 0.075 |
| Example 7 | PE 0.02 | PA 0.035 | — | PE/PA/PE 0.075 |
| Example 8 | PE 0.02 | PVC 0.035 | — | PE/PVC/PE 0.075 |
| Example 9 | PE 0.02 | EVOH 0.035 | — | PE/EVOH/PE 0.075 |
| Example 10 | PE 0.02 | EVA 0.035 | — | PE/EVA/PE 0.075 |
| Example 11 | PE 0.02 | IONO 0.035 | — | PE/IONO/PE 0.075 |
| Example 12 | PSF 0.02 | PEN 0.035 | — | PSF/PEN/PSF 0.075 |
| Example 13 | PSF 0.02 | PET 0.035 | — | PSF/PET/PSF 0.075 |
| Example 14 | PSF 0.02 | PPS 0.035 | — | PSF/PPS/PSF 0.075 |
| Example 15 | PPa 0.02 | PTFE 0.1 | — | PPa/PTFE/PPa 0.14 |
| Example 16 | PPa 0.02 | PVDF 0.1 | — | PPa/PVDF/PPa 0.14 |
| Example 17 | PPa 0.02 | PFA 0.1 | — | PPa/PFA/PPa 0.14 |
| Example 18 | PPa 0.02 | FEP 0.1 | — | PPa/FEP/PPa 0.14 |
| Example 19 | PE 0.02 | PET 0.035 | Au 0.01 | PE/Au/PET/PE 0.085 |
| Example 20 | PE 0.02 | PET 0.035 | Pt 0.01 | PE/Pt/PET/PE 0.085 |
| Example 21 | PE 0.02 | PET 0.035 | Ni 0.01 | PE/Ni/PET/PE 0.085 |
| Example 22 | PE 0.02 | PET 0.035 | Cu 0.01 | PE/Cu/PET/PE 0.085 |
| Example 23 | PE 0.02 | PET 0.035 | Sn 0.01 | PE/Sn/PET/PE 0.085 |
| Example 24 | PE 0.02 | PET 0.035 | Ti 0.01 | PE/Ti/PET/PE 0.085 |
| Example 25 | PE 0.02 | PET 0.035 | Si 0.01 | PE/Si/PET/PE 0.085 |
| Example 26 | PPa 0.02 | PEN 0.035 | — | PPa/PEN/PPa 0.075 |
| Comp. Ex. 1 | PA 0.02 | AL 0.035 | — | PA/AL/PA 0.075 |
| Comp. Ex. 2 | PE 0.05 | — | — | PE 0.05 |
| Comp. Ex. 3 | PPa 0.05 | — | — | PPa 0.05 |
| Comp. Ex. 4 | — | PET 0.05 | — | PET 0.05 |
| Comp. Ex. 5 | — | PPS 0.05 | — | PPS 0.05 |

### Examples 15 to 18

Acid-modified polypropylene (PPa) having a thickness of 0.02 mm was used as hydrogen gas permeating materials, fluorine-containing polymer materials were used as gas barrier materials, and the combinations of the configuration and thicknesses thereof are shown in Table 1. The hydrogen gas permeating materials were adhered to the fluorine-containing polymer materials by surface-modifying the surfaces of the fluorine-containing polymer material sheets by corona discharge, roll-coating modified polybutadiene, which was an anchor coating agent, on the surface of the fluorine-containing polymer material sheets, and bonding the hydrogen gas permeating material sheets on the coating surface. Except using these, thin air batteries were fabricated in the same configurations as in Example 1.

### Examples 19 to 25

Polyethylene (PE) was used as hydrogen gas permeating materials, polyethylene terephthalate (PET) was used as gas barrier materials, and the package sheets containing metal sheet layers were fabricated in combination of the configurations and thicknesses shown in Table 1. As the metals, gold (Au), platinum (Pt), nickel (Ni), copper (Cu), tin (Sn), titanium (Ti), and silicon (Si) were used. The metal sheet layers were formed by the vapor deposition of a metal on a PET sheet of 0.035 mm so as to be a thickness of 0.01 mm. Thereafter, PE in a molten state was applied onto the both surfaces of the metal-deposited PET sheet to form a package sheet. Except using these, thin air batteries were fabricated in the same configurations as in Example 1.

### Example 26

A thin air battery having the same configuration as in Example 1 except only the negative electrode was changed was fabricated. The negative electrode was formed as follows. As the active material of the negative electrode 11, the same particulate zinc alloy as in Example 1 was used, and after mixing 3% by weight of polyacrylate powder to the zinc alloy, the quantity wherein the mass ratio of the electrolyte to the negative electrode active material is 0.5:1 of the same alkaline electrolyte as in Example 1 was added to gel the active material. Thereafter, the gelled active material was packed in the depression of the third sheet layer 4 drawn to a depth of 1.0 mm by a hot press. As the current collector, a copper mesh with a wire diameter of 0.03 mm and an opening area rate of 37% whose surface was subjected to electrolytic tin plating was used. The gelled active material was contacted to the current collector in the depression of the third sheet layer 4 so that the entire current collector was covered with the gelled active material, to secure electrical connection. The packing quantity of zinc was designed so that the theoretical discharge capacity of the air battery became 2500 mAh.

### Comparative Example 1

Each of the sheet layers 1, 3, and 4 of the package was made to be a three-layer structure of a total thickness of 0.075 mm wherein the hydrogen gas permeating material in Examples was substituted by a gas barrier polyamide (PA, nylon 66), the gas barrier material was substituted by an aluminum foil (Al) of a thickness of 0.035 mm, and the both surfaces of Al were covered with PA. Otherwise, the thin air battery was fabricated in the same configuration as in Example 1.

### Comparative Examples 2 and 3

The sheet layers 1, 3, and 4 of packages were composed only of hydrogen gas permeating materials, which were polyethylene (PE) and acid-modified polypropylene (PPa) each having a thickness of 0.05 mm. Except using these, thin air batteries were fabricated in the same configurations as in Example 1.

### Comparative Examples 4 and 5

The sheet layers 1, 3, and 4 of packages were composed only of gas barrier materials, which were polyethylene terephthalate(PET) and polyphenylene sulfide (PPS) each having a thickness of 0.05 mm. Except using these, thin air batteries were fabricated in the same configurations as in Example 1.

Ten thin air batteries from each of the above-described Examples 1 to 24 and Comparative Examples 1 to 5 were stored under conditions of a temperature of 45° C. and a relative humidity of 90% for 20 days in the state of sealing air holes, and rise in the internal resistance (alternating current method 1 kHz), amount of expansion, and capacity on 50 mA constant current discharge of the batteries after storage were measured. The results of measurements are shown in Table 2 as mean values of 10 measurements.

TABLE 2

| | Increase in | | 50 mA |
|---|---|---|---|
| | internal | Amount of | discharge |
| | resistance | expansion | capacity |
| | (Ω) | (mm) | (mAh) |
| Example 1 | 0.5 | 0.2 | 2330 |
| Example 2 | 0.6 | 0.2 | 2280 |
| Example 3 | 0.4 | 0.2 | 2380 |
| Example 4 | 0.4 | 0.3 | 2220 |
| Example 5 | 0.8 | 0.3 | 2070 |
| Example 6 | 0.8 | 0.4 | 2090 |
| Example 7 | 0.9 | 0.4 | 2030 |
| Example 8 | 0.8 | 0.4 | 2040 |
| Example 9 | 0.9 | 0.4 | 2070 |
| Example 10 | 0.9 | 0.4 | 2010 |
| Example 11 | 0.8 | 0.3 | 2060 |
| Example 12 | 0.2 | 0.1 | 2400 |
| Example 13 | 0.2 | 0.1 | 2390 |
| Example 14 | 0.1 | 0.1 | 2430 |
| Example 15 | 0.1 | 0.1 | 2460 |
| Example 16 | 0.1 | 0.1 | 2440 |
| Example 17 | 0.1 | 0.1 | 2470 |
| Example 18 | 0.1 | 0.1 | 2460 |
| Example 19 | 0.1 | 0.1 | 2460 |
| Example 20 | 0.1 | 0.1 | 2470 |
| Example 21 | 0.1 | 0.1 | 2480 |
| Example 22 | 0.1 | 0.1 | 2470 |
| Example 23 | 0.1 | 0.1 | 2460 |
| Example 24 | 0.1 | 0.1 | 2450 |
| Example 25 | 0.1 | 0.1 | 2460 |
| Example 26 | 0.6 | 0.3 | 2300 |
| Comp. Ex. 1 | 9.5 | 0.9 | 620 |
| Comp. Ex. 2 | 10.2 | 0.1 | 440 |
| Comp. Ex. 3 | 9.1 | 0.2 | 470 |
| Comp. Ex. 4 | 8.7 | 1.1 | 360 |
| Comp. Ex. 5 | 9.3 | 1.0 | 330 |

As Table 2 shows, correlation was observed between rise in the internal resistance, amount of expansion, and discharge capacity of the batteries after storage at 45° C. and a relative humidity of 90% for 20 days. Both rise in the internal resistance and amount of expansion were largest and the discharge capacity was markedly lowered in Comparative Example 1. When a hole was drilled in the package sheet layer of the battery after storage, gas was leaked from the inside. When the composition of the gas was analyzed, hydrogen gas was detected. Therefore, the expansion of the battery is caused by the generation of hydrogen gas from the negative electrode.

Since the battery of Comparative Example 1 is composed of gas barrier polyamide (PA) in place of a hydrogen gas permeating material in Examples, hydrogen gas generated from the negative electrode cannot be permeated and escape to the outside, and expansion is large. As a result of alternating current impedance measurements before and after storage, the quantity of the reaction resisting component largely increased. From these facts, it was suggested that the boundary state between the negative electrode and the positive electrode was changed.

The extreme lowering of discharge capacity, that is the lowering of zinc utilization rate, is due to increase in the quantity of the reaction resisting component and the lowering of reaction efficiency. In addition, in Comparative Example 1, the corrosion was found in one of ten aluminum foils used as the gas barrier material. As a result of analysis, minute scratch was found in a polyamide portion. It is considered that this scratch was produced due to excessive contact of the polyamide portion to the negative electrode current collector. The corrosion of the aluminum foil is due to that the alkaline electrolyte reaches the aluminum foil through the scratched portion during the storage period. The use of aluminum foil in the package is not preferable because of corrosion by the alkaline electrolyte.

In the batteries of Comparative Examples 2 and 3, since the package sheet is composed only of a hydrogen gas permeating material, hydrogen gas generated from the negative electrode can escape to the outside by permeation through the package sheet to the outside, expansion is small. On the other hand, both rise in the internal resistance and the lowering of discharge capacity were significant. When these batteries were disassembled and the ion conductivity of the alkaline electrolyte was measured, the ion conductivity was markedly lowered compared with that before storage. Therefore, the cause of significant rise in the internal resistance or the lowering of the discharge capacity was considered to be the reaction of water vapor and carbon dioxide invaded into the battery through the package sheet with the alkaline electrolyte during the storage period. It is difficult to suppress the lowering of battery characteristics during the storage period by composing the package sheet only of the hydrogen gas permeating material as described above.

In the batteries of Comparative Examples 4 and 5, since the package sheet is composed only of the gas barrier materials, hydrogen gas generated from the negative electrode cannot escape to the outside by permeation through the package sheet, and expansion is large. As a result of measuring the alternating current impedance of these batteries before and after storage, the quantity of the reaction resisting component largely increased after storage. From these facts, it is suggested that the boundary state between the negative electrode and the positive electrode is changed by expansion. It is difficult to suppress the lowering of battery characteristics during the storage period by composing the package sheet only of the gas barrier material as described above.

On the other hand, in the batteries of Examples 1 to 14, it is known that both rise in the internal resistance and the expansion of the battery are more suppressed than Comparative Example 1, and hydrogen gas generated from the negative electrode during the storage period is exhausted to the outside through the layer of the hydrogen gas permeating material. In Examples 12 to 14, wherein polysulfone having large hydrogen gas permeability is used, rise in the internal resistance and the expansion of the battery are less than those in other Examples, and the discharge capacity maintaining rate is also as very high as 90% or more.

In the batteries of Examples 15 to 18, it is known that both rise in the internal resistance and the expansion of the battery are more suppressed than Comparative Example 1, and hydrogen gas generated from the negative electrode during the storage period is exhausted to the outside through the layer of the hydrogen gas permeating material. Also in the battery of Examples 15 to 18, the discharge capacity maintaining rate is more improved than those of Examples 1 to 14, and there is possibility that the layer of the fluorine-containing polymer material further suppresses the invasion of water vapor, carbon dioxide, and oxygen into the battery. Thus, reliability is more improved by the presence of a fluorine-containing polymer material layer.

In the batteries of Examples 19 to 25, it is known that both rise in the internal resistance and the expansion of the battery are more suppressed than Comparative Example 1, and hydrogen gas generated from the negative electrode during the storage period is exhausted to the outside through the layer of the hydrogen gas permeating material. Also in the battery of Examples 19 to 25, the discharge capacity maintaining rate is more improved than those of Examples 1 to 14, and the discharge capacity maintaining rate is slightly higher than that of Examples 15 to 18. Since the metal sheet layer is considered to almost completely prevent the permeation of gas, the lowering of discharge capacity is considered to be probably only due to self-discharge reaction of the negative electrode active material. Thus, reliability is more improved by the presence of a metal sheet layer.

As described above, thin air batteries of Examples have very high reliability.

In the battery of Example 26, both rise in the internal resistance and the expansion of the battery were substantially the same as those in Example 1, except the negative electrode. This result shows that the configuration of the negative electrode is sufficient by contacting a gelled active material with a current collector.

### INDUSTRIAL APPLICABILITY

The present invention can provide a thin air battery having high capacity and high reliability by using a sheet-like package in which a hydrogen gas permeating material and a gas barrier material are integrated. The thin air battery of the present invention is useful as a driving power source for electronic devices, such as portable terminals and small audio systems.

1. A thin air battery comprising:
a power-generating element composed of a laminate in which air diffusing paper, a water repellent film, an air electrode, a separator, and a negative electrode are stacked in this order, and an electrolyte is contained in the air electrode, separator, and negative electrode;
a package composed of a first sheet layer having air inlet holes and covering the air electrode side of the power-generating element, a third sheet layer covering the negative electrode side of the power-generating element, and a second sheet layer located in the peripheral portion between the first sheet layer and the third sheet layer and joined to the two sheet layers; and
a lead of the air electrode and a lead of the negative electrode drawn out of the package from between the second sheet layer and the first sheet layer or third sheet layer; wherein
the first sheet layer, second sheet layer, and third sheet layer each comprise of a thin film formed by stacking at least an alkali-resistant polymer film having hydrogen gas permeability and a polymer film having gas barrier properties; and in each of the first sheet layer and the third sheet layer, the polymer film having hydrogen gas permeability is disposed on the internal surface side.

2. The thin air battery according to claim 1, wherein the polymer film having hydrogen gas permeability is composed of a material selected from the group consisting of polyethylene, polypropylene, and polysulfone.

3. The thin air battery according to claim 1, wherein the polymer film having gas barrier properties is composed of a material selected from the group consisting of polyethylene naphthalate, polyethylene terephthalate, polyphenylene sulfide, polyamide, polyvinyl chloride, ethylene-vinyl alcohol copolymers, ethylene-vinyl acetate copolymers, and ionomer resins.

4. The thin air battery according to claim 1, wherein the polymer film having gas barrier properties is composed of a fluorine-containing polymer material.

5. The thin air battery according to claim 1, wherein at least one of the first sheet layer, second sheet layer, and third sheet layer comprises a metal sheet layer that is not corroded by aqueous alkaline solutions.

6. A thin film for a package of an alkaline battery formed by stacking at least an alkali-resistant polymer film having hydrogen gas permeability and a polymer film having gas barrier properties.
